(19) United States
(12) Patent Application Publication
(10) Pub. No.: US 2026/0125933 A1
(43) Pub. Date: May 7, 2026

(54) LOCKING DEVICE

(71) Applicant: Securitech Group, Inc., Maspeth, NY (US)

(72) Inventors: Mark J. Berger, New York, NY (US); David Mate, Maspeth, NY (US)

(73) Assignee: Securitech Group, Inc., Maspeth, NY (US)

(21) Appl. No.: 19/373,375

(22) Filed: Oct. 29, 2025

Related U.S. Application Data
(60) Provisional application No. 63/715,201, filed on Nov. 1, 2024.

(51) Int. Cl. E05B 63/00; E05B 13/00; E05B 35/10; E05B 47/00; E05B 63/14

(52) U.S. Cl. CPC E05B 63/0069; E05B 13/002; E05B 35/105; E05B 47/0002; E05B 63/143

(57) ABSTRACT

A locking device includes two locks, a supervisor-lock that controls the operability of a user-lock, and the user-lock that can unlock an associated door is disclosed. The locking device requires that both the supervisor-lock and the user-lock are unlocked for an associated door to open. Thus, if the supervisor-lock is locked, the user-lock cannot be unlocked.

### CROSS-REFERENCE TO RELATED APPLICATIONS

This application claims the benefit of priority under 35 U.S.C. § 119(e) to U.S. Provisional Application Ser. No. 63/715,201 titled “LOCKING DEVICE” filed on Nov. 1, 2024, which is hereby incorporated by reference in its entirety.

### FIELD

Disclosed embodiments are related to a locking device having a first lock that controls the operability of a second lock.

### BACKGROUND

Locking devices routinely include a locking mechanism that is freely actuatable with the appropriate key. Once a user has the appropriate key, they can unlock the locking mechanism and enter the secured space—even if a supervisor wishes to limit the accessibility of a secured area. Currently, there are no means for the supervisor to govern keyholder access to a space by limiting the functionality of the locking mechanisms within the lock itself to control the unlockability of a door lock.

### SUMMARY

In some embodiments, a locking-device is disclosed. The locking-device has a locked locking-device state and an unlocked locking-device state comprising. The locking-device includes a supervisor-lock that is movable between a supervisor-lock locked position and a supervisor-lock unlocked position. The locking-device also includes a user-lock that is movable between a user-lock locked position and a user-lock unlocked position. When the supervisor-lock is in the supervisor-lock locked position, it is configured to prevent the user-lock from moving from the user-lock locked position to the user-lock unlocked position. And when the supervisor-lock is in the supervisor-lock unlocked position, the user-lock is movable between the user-lock locked position and the user-lock unlocked position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a locking-device with a handle actuator on an associated door;

FIG. 2 is a front view of the locking-device;

FIG. 3 is an internal back view of the locking-device;

FIG. 4 is an expanded internal view of the handle actuator portion of the locking-device;

FIG. 5 is an internal back view of the locking-device wherein a supervisor-lock is in an unlocked position and a user-lock is in a locked position;

FIG. 6 is the internal view of FIG. 5 wherein the supervisor-lock is in the unlocked position and the user-lock is in an unlocked position;

FIG. 7 is the internal view of FIG. 5 wherein the supervisor-lock is in the locked position;

FIG. 8 is a perspective view of the locking-device without its outer shell, and

FIG. 9 is an alternative embodiment of the locking-device with an electromechanical actuator.

### DETAILED DESCRIPTION

Generally, a single lock is used to control access to a space. However, in some instances, a supervisor may want to limit an authorized user's ability to enter a secured location. To achieve this goal with traditional locking-devices, a supervisor could reclaim the physical key from the authorized user. However, reclaiming keys may be laborious, particularly if the authorized user cannot be located, or if multiple keys were distributed. Furthermore, to reauthorize access, the supervisor would need to return the keys. Alternatively, the supervisor could change the key cylinder. However, then the supervisor must purchase and install new components, and they would still need to reissue new keys to reauthorize access. It is apparent that both solutions are cumbersome, and neither offer the supervisor a way to easily and reversibly limit the access to a secured location to an authorized key holder with minimal intervention.

In view of the above, the inventors appreciate that a primary supervisor-lock may be implemented to control the functionality of a user-lock.

The ability of the user-lock to function, i.e., to lock and unlock a locking-device affixed to an associated door, can be controlled by a supervisor-lock. In this case, when the supervisor-lock is unlocked, the user-lock can unlock or lock the locking-device; and when the supervisor-lock is locked, the user-lock cannot be unlocked. As detailed below, the supervisor-lock functions by prohibiting actuation of the user-lock into the user-lock unlocked position by obstructing the movement of its associated components. Accordingly, the locking-device (and therefore the associated door) can only be unlocked when both the supervisor-lock and the user-lock are in their second unlocked positions. Therefore, a supervisor can easily control an individual's or group's access to a space in one step by limiting actuation of the lock that controls entry.

The device may also contain (or otherwise be associated with) a handle actuator. The handle actuator may be a traditional rotatable handle actuator, however other handle actuators, such as a push bar actuator, may be used with some modification, as will be appreciated by the disclosure below. The actuation of the handle actuator may allow for the associated door to move from a closed position to an open position. In short, when the handle actuator is in the first handle actuator position the associated door cannot open. However, in the second handle actuator position the associated door may be openable. Other arrangements for controlling the openability of an associated door without a handle actuator can be implemented.

According to one embodiment, the supervisor-lock and the user-lock may each include a mechanical lock with a key cylinder that is actuatable via a physical key. The key cylinder associated with the mechanical supervisor-lock lock can actuate one or more physical components in the locking-device, such as a switch, from a first position to a second position. This movement may prohibit or enable, respectively, the un-lockability of the locking-device. Similarly, the key cylinder associated with the mechanical user-lock lock can actuate one or more physical components in the locking-device, such as a rotatable trident, from a first position to a second position. Actuation of this key cylinder locks and unlocks the locking-device, and therefore, it may prohibit or enable the openability of the associated door.

In some embodiments, the supervisor-lock may include an electromechanical actuator. In said embodiment, the supervisor-lock may be actuated via a processor receiving a virtual key from a source. In response to this signal, the electromechanical actuator may directly actuate the supervisor-lock or components of the user-lock. In some embodiments, the electromechanical actuator may be a solenoid or a servo. However, other electromechanical actuators may be implemented. In this embodiment, the user-lock may be a mechanical lock. However, in other embodiments, the user-lock may also include an electromechanical actuator. Furthermore, in some additional embodiments, the user-lock may include an electromechanical actuator, and the supervisor-lock may include a mechanical lock.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

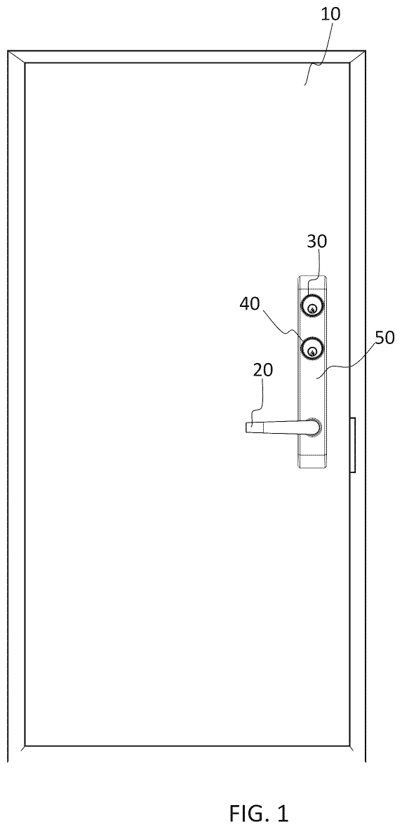

FIG. 1 depicts the locking-device 50 secured to an associated door 10. The locking device has a locked locking-device state and an unlocked locking-device state. When the locking-device is in the locked locking-device state, the associated door cannot move into its open position; and when the locking-device is in its unlocked locking-device state, the associated door may be movable between its first closed position and second open position. In the depicted embodiment of FIG. 1, the associated door is in a first closed position. Although the locking-device is shown to be attached to the associated door, the locking-device may be attached to other structures.

The depicted embodiment includes a handle actuator 20. The handle actuator is movable between a first handle actuator position and a second handle actuator position. As will be appreciated below, in the depicted embodiment, the handle actuator must be actuated for the associated door to transition from its closed position to its open position. Although the depicted embodiment includes a handle actuator, a person of ordinary skill would understand that other actuators, such as a push bar, may be substituted. Furthermore, a person of ordinary skill would appreciate that the locking-device could be operated independently from a handle actuator.

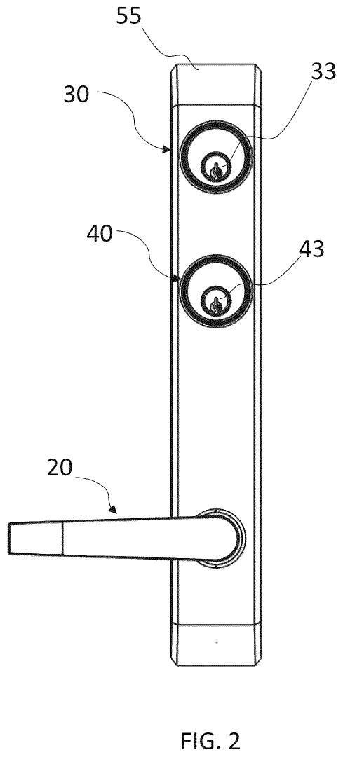

FIG. 2 depicts a closer view of the locking-device 50 according to the depicted embodiment. The locking-device includes a supervisor-lock 30 and a user-lock 40. The supervisor-lock includes a supervisor-lock key cylinder 33, and the user-lock includes a user-lock key cylinder 43.

The supervisor-lock is movable between a supervisor-lock locked position and a supervisor-lock unlocked position. Like the supervisor-lock, the user-lock is movable between an unlocked position called a user-lock locked position, and an unlocked position called a user-lock unlocked position. Both the supervisor-lock key cylinder 33 and the user-lock key cylinder 43 have a portion accessible on the outside of the device that enables actuation of their respective inner mechanics. Accordingly, the supervisor-lock key cylinder is movable from a first position called the first supervisor-lock key cylinder position to a second position called the second supervisor-lock key cylinder position. Likewise, the user-lock key cylinder is movable between a first user-lock key cylinder position and a second user-lock key cylinder position.

The inner mechanics of the locking-device are covered by an outer shell 55. The outer shell may have a rear portion that is in contact with an associated door, and a front portion that encases the inner components of the device. The front portion and the rear portion of the device may be one component. In some embodiments, there may be no rear portion of the outer shell, and the inner components may be encased by mating the outer shell to the associated door. The outer shell 55 helps to provide a secure attachment to the associated door, protect the inner components of the device while permitting operation, and support the inner mechanics.

The locking-device may be securely attached to the associated door with fasteners. Although the fasteners and fastener attachment means are not depicted in the figures, a person of ordinary skill would understand how to secure the device to the associated door.

The outer shell 55 wraps around the outer components of the supervisor-lock 30, the user-lock 40, and the handle actuator 20. In the depicted embodiment, the outer shell is shaped so that the supervisor-lock key cylinder 33 is positioned above the user-lock key cylinder 43, and both key cylinders are positioned above the handle actuator 20. However, this is not intended to be limiting, as the outer shell can be modified to accommodate other device configurations. In some embodiments, the user-lock key cylinder may be positioned above the supervisor-lock key cylinder and both may be above the handle actuator. In other embodiments, the supervisor-lock key cylinder may be below the handle actuator, while the user-lock key cylinder is above the handle actuator. In some other embodiments, the user-lock key cylinder may be below the handle actuator, while the supervisor-lock key cylinder may be above the handle actuator. Additionally, in some embodiments, the supervisor-lock key cylinder and the user-lock may be positioned below the handle actuator.

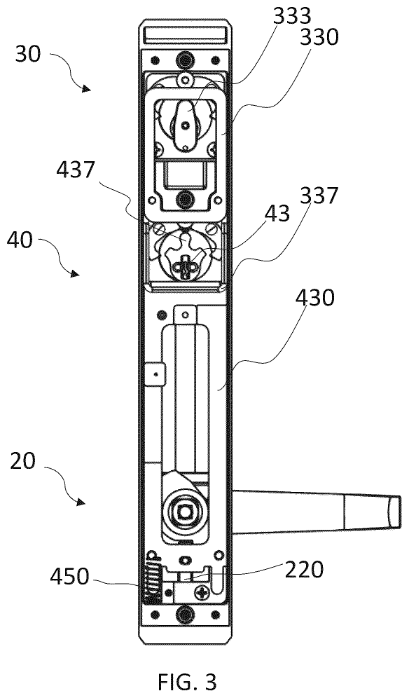

FIG. 3 depicts the back side of the locking-device according to one embodiment without the outer shell. Here, the inner components and mechanisms of the supervisor-lock 30, the user-lock 40 and the handle actuator 20 are illustrated. In this illustration, the supervisor-lock 30 occupies around the top third of the device. The supervisor-lock includes a supervisor-lock key cylinder, a switch 333 and a slide gate 330. The user-lock 40, which occupies approximately the bottom two-thirds of the device, includes a user-lock key cylinder 43, a sliding plate 430, and a rotatable trident 437. While the bottom third of the device includes the handle actuator 20, the bias 450 and the obstruction 433. However, as detailed above, in other embodiments the supervisor-lock, the user-lock, and the handle actuator may be in different positions and may occupy different proportions of the device. These locational details are merely descriptive of the positioning of the components illustrated in the detailed embodiment, and although this configuration is used to describe the device, it should not be construed as limiting.

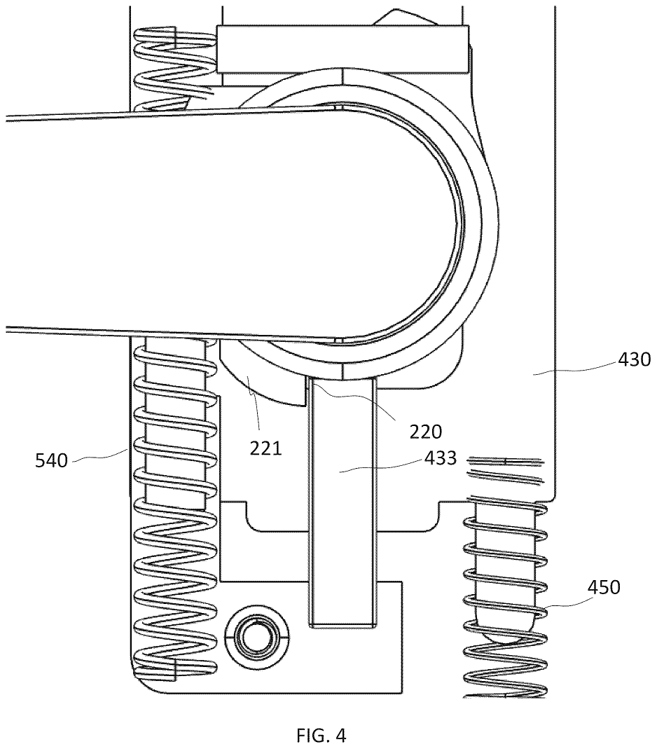

The mechanics of the bottom third of the device without the outer shell are shown in more detail in FIG. 4. Here, a front view of a portion of the device including the handle actuator 20, the bias 450 and the obstruction 433 of the locking-device is illustrated when the handle actuator is in the first handle actuator position.

As shown in FIG. 4, the handle actuator 20 includes an outer extended portion 221, which also includes a void that forms a recess 220. The recess 220 and the outer extended portion 221 each are movable between a first position and a second position, called a first recess position and a second recess position, and a first outer extended position and a second outer extended position, respectively. The outer extended portion 221 and the recess 220 are associated with the handle actuator 20, such that when the handle actuator rotates from the first handle actuator position to the second handle actuator position, the recess 220 moves between the first recess position and second recess position, and the outer extended portion 221 also moves between the first outer extended portion position and the second outer extended portion position. In the depicted embodiment, the extended portion 221 and the recess 220 are part of the handle actuator, but they may be separate components that rotate with the handle actuator.

The handle actuator 20 also includes a handle actuator bias 540. The handle actuator bias includes a top portion that is attached to the handle actuator 20, and a bottom portion that is secured to the inside of the outer shell 55. When the force acting on the handle actuator 20 is less than the force of the handle actuator bias 540, the handle actuator bias will move the handle actuator 20 and the recess 220 towards their first positions from their second positions. Accordingly, the handle actuator 20 and the recess 220 are biased towards the first handle actuator position and the first recess position, respectively. In the depicted embodiment, the handle actuator bias 540 is a spring, however other means of creating a bias, such as an elastic, may be substituted.

The device also includes an obstruction 433 that is movable between a first obstruction position and a second obstruction position via actuation of the user-lock 40. The obstruction is shaped to fit within the recess 220, such that when the obstruction 433 is in the first obstruction position, the obstruction rests within the recess. In this position, the obstruction 433 blocks the outer extended portion 221 from rotating from the first outer extended portion position into the second outer extended portion position, which in turn also prevents the handle actuator 20 from rotating to the second handle actuator position.

However, when the obstruction 433 is in the second obstruction position, the obstruction is spaced from the recess 220 so that the handle actuator 20 is rotatable into a second handle actuator position. FIG. 4 depicts the obstruction in the first obstruction position.

Although a recess and an obstruction are used in the depicted embodiment, it should be appreciated that other means of stopping the actuation of the handle actuator can be implemented. Furthermore, as stated above, other types of actuators may be used in place of the handle actuator, such as a push bar. As such, based on this disclosure, a person of ordinary skill would understand how to change the device as to prevent the movement of the handle actuator 20 from the first handle actuator position to the second handle actuator position based on the handle actuator used in association with the locking device.

In addition to complementing the shape of the recess, the obstruction 433 is additionally shaped to be actuated by the user-lock 40. In the depicted embodiment, the obstruction 433 is directly and securely attached to the sliding plate 430 of the user-lock 40. It should be noted that this disclosure is not intended to be limiting, as the sliding plate and the obstruction may be continuous, the obstruction may not be attached to the sliding plate, or the obstruction may not be directly connected to the sliding plate.

Like the obstruction 433, the sliding plate 430 is movable between a first sliding plate position and a second siding plate position via actuation of the user-lock 40. Accordingly, when the sliding plate 430 is in the first sliding plate position, the obstruction is in the first obstruction position; and when the sliding plate is in the second sliding plate position, the obstruction is also in the second obstruction position In the depicted embodiment, the obstruction 433, and the sliding plate 430 are biased towards their first positions by a bias 450. In the depicted embodiment, the bias 450 is a spring that has a top portion that is secured to the bottom of the sliding plate 430 and a bottom portion that is secured to the inside of the outer shell 55. Accordingly, in the depicted embodiment, the bias 450 exerts a direct upward force on the sliding plate 430. However, in other embodiments, other means of creating a bias may be substituted. Furthermore, other positionings of the bias, such as attaching a downward bias to the top portion of the sliding plate, may be implemented.

The biasing force created by the bias 450 will be overcome when the sliding plate 430 is moved into the second sliding plate position by the user-lock 40. In the depicted embodiment, the bias 450 will be sufficient to bias at least the sliding plate 430 and the obstruction 433 into their first positions. However, in other embodiments, such as those where the slide gate and the sliding plate are a singular continuous component or where actuation of the supervisor-lock makes the slide gate movable from a first slide gate position into a second slide gate position, the bias 450 may be sufficient to bias the sliding plate 430, the obstruction 433, and the slide gate 330 into their first positions.

As stated above, in some embodiments, there may be a plurality of biases. In this embodiment, there may be a bias biasing the sliding plate into the first sliding plate position and a separate bias biasing the obstruction into the first obstruction position. In this configuration, the obstruction may not be attached to the sliding plate, and instead the obstruction may initially be spaced from the sliding plate, and movement of the sliding plate from the first sliding plate position and the second sliding plate position causes the obstruction to be moved out of the first obstruction position into the second obstruction position. In this embodiment, movement of the sliding plate into its second sliding plate position may be sufficient to overcome both biases.

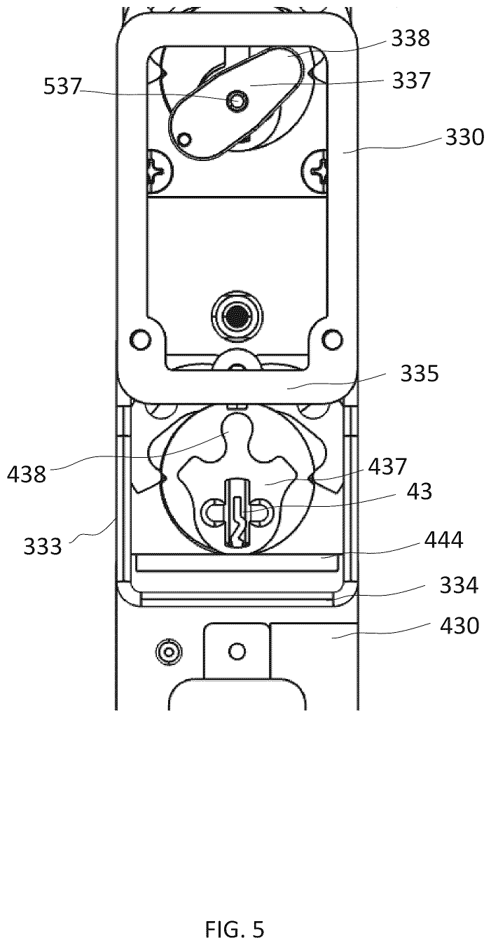

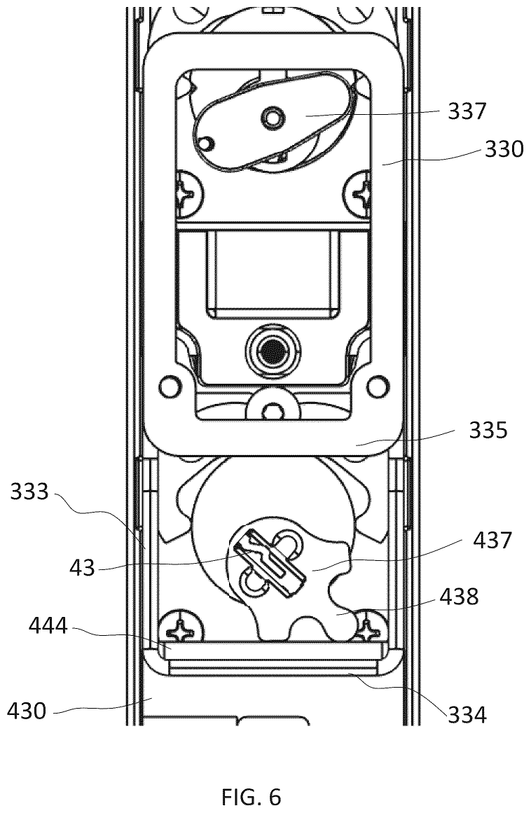

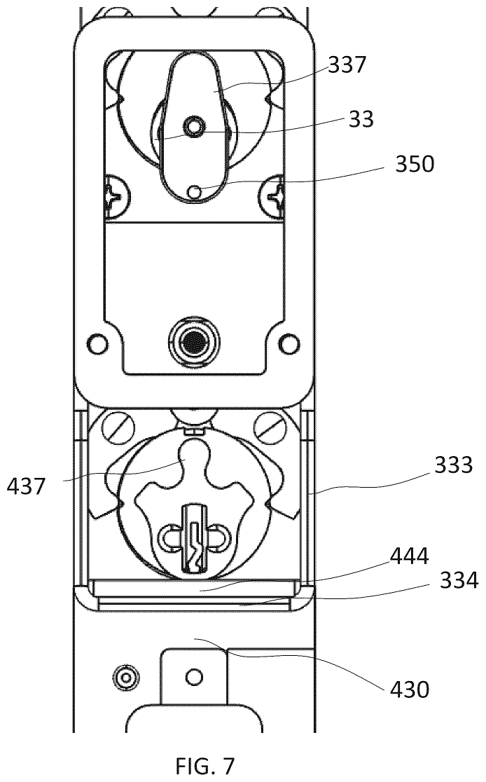

FIG. 5 illustrates a portion of the rear view of the locking-device without the outer shell when the supervisor-lock 30 is in the supervisor-lock unlocked position and the user-lock 40 is in the user-lock locked position. FIG. 6 depicts the perspective of FIG. 5 when the supervisor-lock 30 and the user-lock 40 are in the supervisor-lock unlocked position and the user-lock unlocked position, respectively. FIG. 7 portrays the perspective of FIG. 5 when the supervisor-lock 40 is in the supervisor-lock locked position and the user-lock 30 is in the user-lock locked position.

As stated above, the user-lock 40 includes a rotatable trident 437, a user-lock key cylinder 43 and a sliding plate 430. In the depicted embodiment, the rotatable trident 437 includes a trident apex 438 and two prongs. Although a trident geometry is used for the rotatable trident 437, other geometries may be substituted.

The sliding plate includes a ledge 444. The ledge has a top portion, which may include the top portion of the sliding plate; accordingly, the top portion of the ledge may span from the front edge of the sliding plate to the back edge of the ledge. The rotatable trident 437 interacts with the top portion of the sliding plate. Although a ledge is detailed in the detailed embodiment, other structures that enable the rotatable trident to interface with the sliding plate may be substituted.

In FIGS. 5 and 7 the user-lock 40 is in the user-lock locked position and the sliding plate 430 is pushed up into the first sliding plate position by the bias 450. In the depicted embodiment, the biasing force on the sliding plate 430 pushes the top portion of the ledge 444 into the rotatable trident 437. However, in some embodiments, when the user-lock is in the user-lock locked position, the biasing force may position the top portion of the ledge so that it is below, but not in contact with, the rotatable trident.

When the user-lock is actuated from the user-lock locked position to the user-lock unlocked position, the user-lock key cylinder 43 rotates the rotatable trident 437 from a first rotatable trident position to a second rotatable trident position. As illustrated in FIG. 6, when the rotatable trident 437 is in the second rotatable trident position, the trident apex 438 is at a downward angle. When the trident apex 438 is at a downward angle, the trident apex and one of the prongs pushes the top of the ledge 444 downward. Because the downward force exerted by the rotatable trident 437 on the ledge is greater than the upward force from the bias 450, the sliding plate 430 is moved downward into the second sliding plate position. Furthermore, because the obstruction 433 is attached to the sliding plate, when the rotatable trident 437 is rotated into the second rotatable trident position, the obstruction is displaced from the recess 220. Therefore, when the rotatable trident is in the second rotatable trident position, the handle actuator is movable-and the associated door is unlocked.

However, when the supervisor-lock 30 is in the supervisor-lock locked position, as illustrated in FIG. 7, the sliding plate 430 is prevented from being moved by the supervisor-lock 30.

As stated above, the supervisor-lock includes the supervisor-lock key cylinder 33, the switch 333, and the slide gate 330. The switch 333 has a first switch position and a second switch position. When the supervisor-lock key cylinder 33 is rotated between the first supervisor-lock key cylinder position and the second supervisor-lock key cylinder position, the switch 337 is rotated about a pin 537 between the first switch position and the second switch position. When the switch is in the second switch position, the apex of the switch 338 is in a second apex position, which is closer to the bottom of the device than the apex of the switch in the first switch position. Because the apex of the switch is in contact with a top portion of the slide gate, the lowering of the apex of the switch 338 allows the slide gate 330 to descend from the first slide gate position to the second slide gate position.

In the depicted embodiment, the slide gate 330 descends into the second slide gate position due to the force of gravity. Although, in some embodiments, the slide gate may be biased into the second slide gate position by a supervisor-lock bias. In said embodiment, the biasing force of the supervisor-lock bias may be overcome by the switch when the switch is in the first switch position. However, in other embodiments, a force, such as friction between the slide gate and the outer shell, may hold the slide gate in the first slide gate position until actuation of the user-lock 40 causes the ledge 444 to pull the slide gate into the second slide gate position.

The slide gate 330 includes a slide gate bar 333 and a slide gate base 335. The slide gate bar 333 has a first portion that is attached to the slide gate base 335, and a second portion that is called the interface 334. The slide gate base 335 and the slide gate bar 333 have a first position and second position that follows the first slide gate position and second slide gate position. The first position of the slide gate bar is called the first slide gate bar position, and the second position is called the second slide gate bar position. In the depicted embodiment, regardless of whether the slide gate is in the first slide gate position or the second slide gate position, the interface 334 is positioned below the user-lock key cylinder 43, the rotatable trident 437, and the ledge 444; while the slide gate base 335 is positioned above the user-lock key cylinder, the rotatable trident, and the ledge.

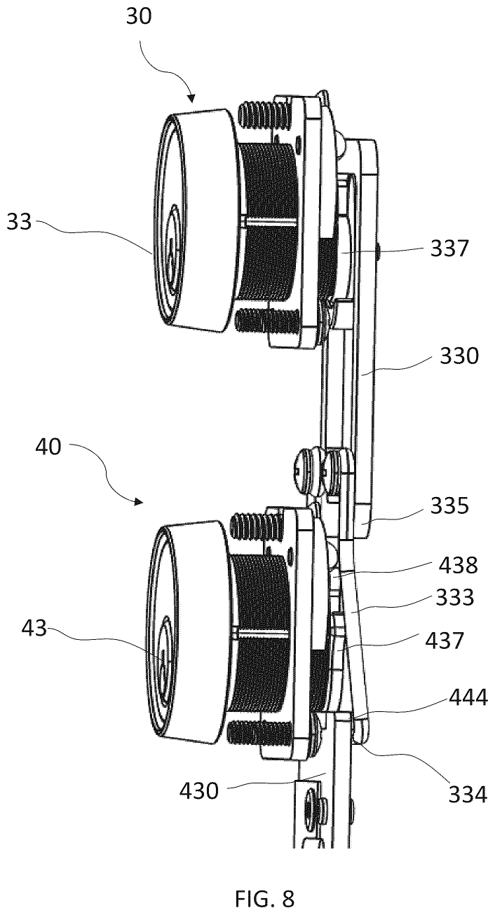

FIG. 8 illustrates a perspective side view of a portion of the locking-device without the external shell when the supervisor-lock 30 and the user-lock 40 are in the supervisor-lock locked positions and the user-lock locked positions, respectively. As displayed in FIGS. 5-8, the slide gate bar is shaped to ensure that the rotatable trident 437 can rotate between the first rotatable trident position and the second rotatable trident position when the supervisor-lock 40 is in the supervisor-lock locked position and the supervisor-lock unlocked position.

In the depicted embodiment, the slide gate bar 333 has a general “U” shape when viewed from the front (X-Y plane) that encircles the rotatable trident 437 and the user-lock key cylinder 43. When viewed from the side (Y-Z plane), the slide gate bar 333 is slightly bent. At the first portion, the slide gate bar 333 is secured to the front of the slide gate base 335 so that it is coplanar with the sliding plate. At one point the slide gate bar extends towards the back of the device, so that at the second portion (the interface 334), the slide gate bar 333 is positioned behind the sliding plate 430 below the ledge 444 and is coplanar with the slide gate 330. The side portions of the slide gate bar are long enough so that the interface 334 is positioned below the ledge and the first portion of the slide gate bar is above the rotatable trident 437 and the user-lock key cylinder 43. This configuration may help to prevent damage to the slide gate bar, (which may impair the function of the locking-device,) if there is an attempt to actuate the user-lock when the supervisor-lock is in the supervisor-lock locked position. However, other geometries and means of preventing damage to the slide gate bar may be substituted. Furthermore, in some cases it may be desirable for the slide gate bar to interact with the rotatable trident or the user-lock key cylinder, therefore, other designs may be substituted.

As illustrated in FIGS. 5-8, the interface 344 on the slide gate bar 333 interfaces with a bottom portion of the ledge 444 on the sliding plate 430. When the slide gate bar 333 is in the first position, the interaction between the interface 344 and the ledge 444 prevents the sliding plate 430 from being pushed into the second sliding plate position by the rotatable trident 437. The switch 337 holds the slide gate bar in the first slide gate bar position.

Accordingly, the switch must be strong enough to prevent the slide gate 335 from moving down into the second slide gate position when there is an attempt to actuate the user-lock 40. It follows, that if the switch can prevent the movement of the slide gate bar into its second position 333 so that the user-lock cannot be actuated, then the obstruction 433 remains in the recess 220, and the handle actuator cannot move to the second handle actuator position.

In the depicted embodiment, the supervisor-lock key cylinder and the switch are different components that are securely connected to each other. However, in other embodiments the supervisor-lock key cylinder and the switch are integrally formed.

Furthermore, in some other embodiments, the supervisor-lock key cylinder and the switch are not directly attached to each other, but the actuation of the supervisor-lock causes the supervisor-lock key cylinder to move the switch from a first switch position to the second switch position. This disclosure is not intended to be limiting.

In the depicted embodiment, the switch is further supported by a ball roller 350, which helps stabilize the device. The ball roller adds an additional support point to the switch, while still enabling the switch to rotate between its first and second position. This helps to prevent the switch from being forced out of alignment with the slide gate when the user-lock is actuated. However, the ball roller may be omitted, or other structures to provide additional support may be substituted.

As illustrated in FIG. 7, when the supervisor-lock is in the first position, the interface contacts the bottom portion of the ledge. However, this is not intended to be limiting, as the interface may be positioned as to enable some movement of the sliding plate, but still prohibit full actuation of the user-lock into the user-lock unlocked position.

In the depicted embodiment, the user-lock 40 may be moved between a second unlocked position into the user-lock locked position by the actuation of the user-lock key cylinder 43 or by retraction via the actuation of the supervisor-lock 30. The latter may be accomplished when both the user-lock and the supervisor-lock are in their second unlocked positions, and the actuation of the supervisor-lock into the supervisor-lock locked position forces the user-lock into the user-lock locked position. In such case, the actuation of the supervisor-lock key cylinder 33 drives (through the switch) the slide gate bar 333 from the second slide gate bar position to the first slide gate bar position, pulling up on the sliding plate 430, which in turn forces the rotatable trident 437 to rotate from the second rotatable trident position to the first rotatable trident position with the sliding plate.

However, such disclosure is not intended to be limiting. In some embodiments, once the force required to actuate the user-lock 40 from the user-lock locked position into the user-lock unlocked position is removed, the user-lock returns to the user-lock locked position. In some other embodiments, the rotatable trident 437 is of such geometry as to prevent the actuation of the supervisor-lock from the supervisor-lock unlocked position into the supervisor-lock locked position when the user-lock is in the user-lock unlocked position. In such an embodiment, the actuation of the supervisor-lock from the supervisor-lock unlocked position into the supervisor-lock locked position would be prevented by the user-lock remaining in the user-lock unlocked position.

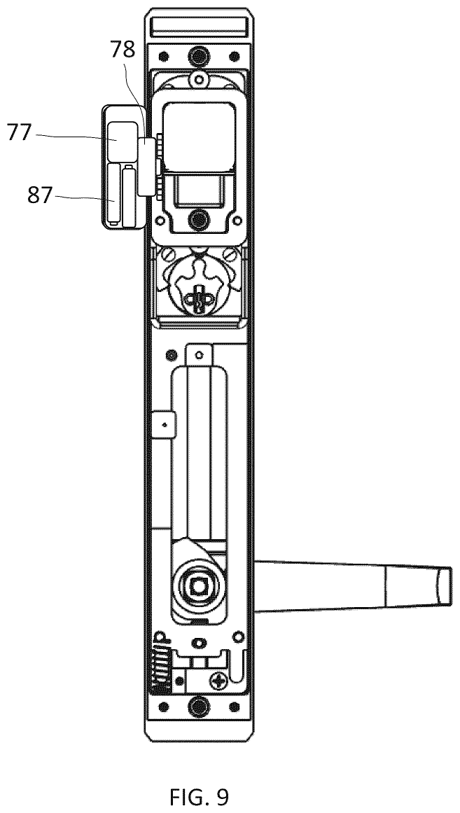

FIG. 9 depicts an alternative embodiment of the locking-device, wherein the supervisor-lock includes an electromechanical actuator 78. The electromechanical actuator has a first electromechanical actuator position and a second electromechanical actuator position.

In this alternative embodiment, the supervisor-lock may not contain a supervisor-lock key cylinder, or a switch. In some embodiments, the supervisor-lock may not include a slide gate. However, in the depicted alternative embodiment, the supervisor-lock includes a slide gate. Moreover, the supervisor-lock may additionally include a battery 87, an internal processor 77, and an external key that emits a signal.

In this embodiment, a signal from an external device is received by the internal processor, the internal processor then actuates an electromechanical actuator. When the electromechanical actuator is in the first electromechanical actuator position, the slide gate is moved into and maintained in the first sliding plate position. When the electromechanical actuator is in its second position, the slide gate is moved into its second slide gate position. In the depicted alternative embodiment, the electromechanical actuator is a servo, however other electromechanical actuators may be used.

The above-described embodiments of the technology described herein can be implemented in any number of ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A locking-device with a locked locking-device state and an unlocked locking-device state comprising:
a supervisor-lock, wherein the supervisor-lock is movable between a supervisor-lock locked position to a supervisor-lock unlocked position; and
a user-lock, wherein the user-lock is movable from a user-lock locked position to a user-lock unlocked position;
wherein, when the supervisor-lock is in the supervisor-lock locked position, the user-lock is not movable from the user-lock locked position to the user-lock unlocked position, and wherein, when the supervisor-lock is in the supervisor-lock unlocked position, the user-lock is movable between the user-lock locked position and the user-lock unlocked position.

2. The locking-device of claim 1, wherein when the supervisor-lock is in the supervisor-lock locked position and the user-lock is in the user-lock locked position, the locking-device is in the locked locking-device state.

3. The locking-device of claim 2, wherein when the user-lock is in the user-lock unlocked position and the supervisor-lock is moved from the supervisor-lock unlocked position to the supervisor-lock locked position, the user-lock is moved from the user-lock unlocked position to the user-lock locked position.

4. The locking-device of claim 1, wherein when the supervisor-lock is in the supervisor-lock unlocked position and the user-lock is in the user-lock unlocked position, the locking-device is in the unlocked locking-device state.

5. The locking-device of claim 4, wherein when at least one of the supervisor-lock is in the supervisor-lock locked position and the user-lock is in the user-lock locked position, the locking-device is in the locked locking-device state.

6. The locking-device of claim 5, further comprising a handle actuator, wherein the handle actuator is movable between a first handle actuator position and a second handle actuator position, wherein when the locking-device is in the locked locking-device state, the handle actuator is not movable between the first handle actuator position and the second handle actuator position, and wherein when the locking-device is in the unlocked locking-device state, the handle actuator is movable between the first handle actuator position and the second handle actuator position.

7. The locking-device of claim 2, wherein the user-lock includes:
a user-lock key cylinder, wherein the user-lock key cylinder is movable between a first user-key cylinder position and a second user-lock key cylinder position; and
a rotatable trident wherein the rotatable trident is movable between a first rotatable trident position and a second rotatable trident position;
wherein movement of the user-lock from the user-lock locked position to the user-lock unlocked position moves the user-lock key cylinder from the first user-lock key cylinder position to the second user-lock key cylinder position, and the rotatable trident from the first rotatable trident position to the second rotatable trident position, and wherein when the rotatable trident moves from the first rotatable trident position to the second rotatable trident position, the locking-device is in the unlocked locking-device state.

8. The locking-device of claim 7, wherein the user-lock further includes:
a sliding plate wherein the sliding plate has a first sliding plate position and a second sliding plate position, wherein movement of the rotatable trident from the first rotatable trident position to the second rotatable trident position moves the sliding plate from the first sliding plate position to the second sliding plate position.

9. The locking-device of claim 8, wherein the supervisor-lock includes:
a supervisor-lock key cylinder, wherein the supervisor-lock key cylinder is movable between a first supervisor-lock key cylinder position and a second supervisor-lock key cylinder position,
a switch movable between a first switch position and a second switch position, and
a slide gate having a first slide gate position and a second slide gate position,
wherein movement of the supervisor-lock from the supervisor-lock locked position to the supervisor-lock unlocked position moves the supervisor-lock key cylinder from the first supervisor-lock key cylinder position to the second supervisor-lock key cylinder position, the switch from the first switch position to the second switch position, and the slide gate from the first slide gate position to the second slide gate position.

10. The locking-device of claim 9, wherein the slide gate further includes a slide gate bar, wherein the slide gate bar has a first slide gate bar position and a second slide gate bar position, and wherein when the slide gate bar is in the first slide gate bar position, the rotatable trident is in the first rotatable trident position.

11. The locking-device of claim 10, further comprising:
a handle actuator, wherein the handle actuator is movable between a first handle actuator position and a second handle actuator position; and
an obstruction, wherein the obstruction is movable between a first obstruction position and a second obstruction position by the movement of the sliding plate, wherein when the obstruction is in the first position, the handle actuator cannot move from the first handle actuator position to the second handle actuator position, wherein when the obstruction is in the second obstruction position, the handle actuator is movable from the first handle actuator position to the second handle actuator position,
wherein when the slide gate bar is in the first slide gate bar position, the sliding plate is in the first sliding plate position, and the obstruction is in the first obstruction position.

12. The locking-device of claim 6, wherein the supervisor-lock includes an electromechanical actuator.

13. The locking-device of claim 12, further comprising a sliding plate, the sliding plate having a first sliding plate position and a second sliding plate position, wherein the electromechanical actuator is a solenoid, wherein when the supervisor-lock is in the supervisor-lock locked position, the solenoid cooperates with the sliding plate to prevent the sliding plate from moving from the first sliding plate position into the second sliding plate position, and the user-lock cannot move into the user-lock unlocked position.

14. The locking-device of claim 12, further comprising a slide gate, the slide gate having a first slide gate position and a second slide gate position, wherein the electromechanical actuator is a servo, wherein when the supervisor-lock is moved from the supervisor-lock locked position to the second position, the servo moves the slide gate from a first slide gate position to the second slide gate position, and the user-lock can move into the user-lock unlocked position.
